(19) United States
(12) Patent Application Publication
(10) Pub. No.: US 2014/0044924 A1
(43) Pub. Date: Feb. 13, 2014

(54) COLOR CONVERSION FILM

(71) Applicant: InnoLux Corporation, Miao-Li County (TW)

(72) Inventors: Jiun-Yi LIEN, Miao-Li County (TW); Chih-Jung CHEN, Miao-Li County (TW); Ruey-Jer WENG, Miao-Li County (TW); Chih-Yung HSIEH, Miao-Li County (TW); Hsu-Kuan HSU, Miao-Li County (TW)

(73) Assignee: InnoLux Corporation, Miao-Li County (TW)

(21) Appl. No.: 13/948,411

(22) Filed: Jul. 23, 2013

(30) Foreign Application Priority Data
Aug. 8, 2012 (TW) 101128574

(51) Int. Cl. G02B 5/22

(52) U.S. Cl. CPC G02B 5/22
USPC 428/156; 428/221

(57) ABSTRACT

A patterned color conversion film is disclosed, which comprises a plurality of pixels made of a fluorescent material; and a plurality of white matrices made of a reflective material such as a white material or metal. The fluorescent film includes a light-input surface and a light-output surface, and the plurality of white matrixes is provided between two adjacent pixels respectively.

### CROSS-REFERENCE TO RELATED APPLICATIONS

The present application relies on Taiwanese Patent Application No. 101128574 filed on Aug. 8, 2012. The abovementioned foreign applications are herein incorporated by reference in their entirety.

### BACKGROUND OF THE INVENTION

The way a fluorescent film prepared by quantum dots or other fluorescent materials emits light is based on excitation by backlight, electrical power and other means. It would therefore make sense to use the fluorescent film as a self-emitting light source, and further to be in conjunction with other light source to arrive at a desired light spectrum. For practical purposes, the fluorescent film can be applied in a display device, in such a way that the film is produced into a patterned color conversion film for down conversion of backlight (i.e. backlight being converted into a light having longer wavelength), so as to replace a color filter and increase light utilization efficiency.

However, because the light emitted from fluorescent matter is not oriented toward any particular direction and can scatter to any direction, portions of light emitted from a pixel can enter adjacent pixels by the guiding effect, and be led into undesirable crosstalk and re-excitation. Accordingly, disposition of a black matrix (BM) between adjacent pixels can be used as a means to resolve the issue that pixel switch is hard to control and to achieve required spectrum.

In the case where the color conversion film is equipped with a black matrix, most of the light beams will be led into the black matrix due to the guiding effect, causing the light beams to less likely enter adjacent pixels to avoid crosstalk, and to prevent light re-excitation induced between different pixels. However, because most of the light beams are absorbed by black matrix, this has led to low light extraction rate and low luminous efficiency.

Therefore, in order to solve the above issue, there is currently a demand for a color conversion film that can increase light extraction rate or luminous efficiency, for the object of reducing magnitude of incident light, and effectively increasing magnitude of light emitted from the color conversion film.

### SUMMARY OF THE INVENTION

An object of the present invention is to provide a patterned color conversion film, so as to prevent crosstalk and re-excitation between pixels, and effectively increasing magnitude of light emitted from the color conversion film.

In order to achieve the above object, the present invention provides a patterned color conversion film, comprising: a plurality of pixels, which is composed of a fluorescent material; and a plurality of white matrices, which is composed of a reflective material; wherein, the color conversion film has a light-input surface and a light-output surface, and the plurality of white matrices are disposed between two adjacent pixels.

The color conversion film of the present invention can further comprise: a plurality of opaque regions, which are disposed on the light-output surface of the plurality of white matrices, for the purpose of avoiding light-output surface from reflecting ambient light and preventing reduction in visibility.

In the color conversion film of the present invention, the cross-sectional area of the plurality of white matrices is not restricted, for example, its shape can be triangular, rectangular, trapezoidal, or a combination thereof. Moreover, the color conversion film can also include various white matrices having different cross-sectional shapes, and the white matrices can vary depending on the desired functionality. The plurality of white matrices is preferred to have an inclined surface. Accordingly, when the color conversion film is excited by the backlight, the emitted light beam reaching the white matrices can be reflected from the white matrices, thereby greatly increasing light extraction rate and luminous efficiency of the color conversion film.

In addition, the angle between the inclined surface and the light-input surface for the white matrix having inclined surface is not restricted, and can vary depending on the need of actual application. Preferably, the angle ranges from 40° to 50°, and an angle between the inclined surface of the white matrix and the light-input surface of the adjacent pixel is larger than 90°. However, the present invention is not limited thereto.

The reflective material for making the white matrix is not particularly restricted, and can be selected from any conventional reflective material. Preferably, the white matrix is made of metal material (e.g. Cr, Al, Cu, Au, etc.) or white reflective material (e.g. barium sulfate, barium carbonate, strontium carbonate, zinc oxide, titanium oxide, magnesium oxide, zirconium dioxide, silica and the like, with high refractive index and visible-light non-absorbing property). It is also practical to mix powders or micro-particles of the above-mentioned materials with a polymer material and execute a shaping process to obtain the white matrix. By way of the foregoing, the reflective material can be selected based on the desired reflective effect. Among the aforementioned materials, the metal surface can provide a nearly ideal reflective plane (ideally defined as incidence angle=reflection angle), and the surface of the white material can approximately function as a diffusion reflective surface, and shows a certain level of scattering.

The fluorescent material for making pixels is not particularly restricted, and it can use any fluorescent material known by conventional practice.

In the color conversion film of the present invention, the color conversion film has a light-input surface and a light-output surface. The light-input surface means the surface of the color conversion film where the backlight enters into the color conversion film, and the light-output surface means the surface of the color conversion film where light is expected to be extracted from the color conversion film. Besides, the light-output surface and the light-output surface can correspond to each other.

Furthermore, the plurality of pixels can be independently selected from the group consisting of a red pixel, a green pixel, a blue pixel, a cyan pixel, a yellow pixel, and a colorless pixel. For example, combination of red, green, and blue pixels (RGB); combination of red, green, blue, and cyan pixels (RGBC); or combination of red, green, blue and yellow pixels (RGBY), etc. may be applied in the present invention. However, the present invention is not limited thereto. The backlight source applied in the present invention is not particularly restricted, and can be selected from blue light, violet light, UV light, or the like, with a shorter wavelength than the emission wavelength of the fluorescent material of the color conversion film. In addition, the plurality of pixels of the current invention can select a colorless (transparent) pixel in conjunction with respective backlight. For example, the plurality of pixels can be a combination of red, green, and colorless pixels, and the colorless (transparent) pixel is further in conjunction with blue backlight source. By way of the foregoing, one skilled person in the art can make suitable variation on the combination of pixel and backlight color according to actual needs.

The color conversion film of the present invention can be prepared by quantum dots, wherein the core/shell material of the quantum dot is not particularly restricted. For example, it can be selected from the group consisting of ZnS, ZnSe, ZnTe, CdS, CdSe, CdTe, MnSe, HgS, HgSe, HgTe, MN, AlP, AlAs, AlSb, GaN, GaP, GaAs, GaSb, GaSe, InN, InP, InAs, InSb, TlN, TlP, TlAs, TlSb, PbS, PbSe, and PbTe; or a semiconductor material having three or more elements (e.g. CdₓZn₁₋ₓS_{y}Se, CdxZn₁₋ₓS, CuInS₂, CuInSe₂, AgInS₂, AgInSe₂, InₓGa₁₋ₓP, CdₓZn₁₋ₓS_{y}Se_{1-y} or its doping type, or MnSe:Cu, MnSe:Mn, CdS:Cu, CdS:Mn, In₂S₃:Cu, ZnO:Cu or ZnO:Mn).

Furthermore, the color conversion film of the present invention can further comprise: a substrate, which is disposed on the light-input surface or the light-output surface of the color conversion film. By way of the above, the color conversion film can further comprise: a plurality of opaque regions, which is respectively disposed on the light-output surface of the plurality of white matrices.

Therefore, the color conversion film of the present invention is disposed with white matrices, so that the light beam that cannot be extracted from pixel due to the guiding effect will arrive at the white matrix, and the light beam would be reflected out of the white matrix, to achieve high light extraction rate or high luminous efficiency. In addition, the color conversion film of the present invention can effectively ward off crosstalk induced by light entry into adjacent pixels, and re-excitation induced between different pixels.

### BRIEF DESCRIPTION OF THE DRAWINGS

FIG. 1 shows a color conversion film of embodiment 1 according to the present invention.

FIG. 2 shows a color conversion film of embodiment 2 according to the present invention.

FIG. 3 shows a color conversion film of embodiment 3 according to the present invention.

FIG. 4 shows a color conversion film of embodiment 4 according to the present invention.

### DETAILED DESCRIPTION OF THE PREFERRED EMBODIMENT

In the drawings provided for illustrating the embodiments, the dotted arrow represents the direction to which the backlight enters into the color conversion film; the solid arrow represents the direction from which light is extracted from the color conversion film for desired use in display.

### EMBODIMENT 1

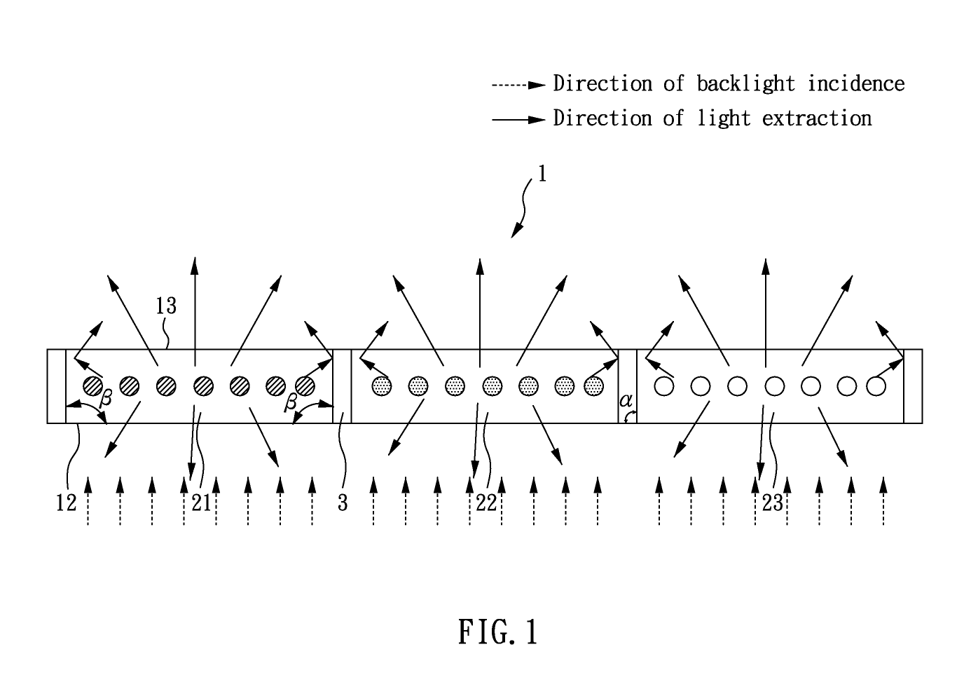

In reference to the color conversion film 1 shown in FIG. 1, it comprises: a plurality of patterned pixels, which includes a blue pixel 21, a red pixel 22, and a green pixel 23; and a plurality of white matrices 3, which is composed of barium sulfate. The color conversion film has a light-input surface 12 and a light-output surface 13, and the plurality of white matrices 3 are placed between two adjacent pixels. In this illustration, the cross-sectional surfaces of the plurality of white matrices are rectangular in shape; the angle α between the inclined surface and the light-input surface of the white matrix, and the angle β between the inclined surface of the white matrix and the light-input surface of the adjacent pixel are both 90°.

### EMBODIMENT 2

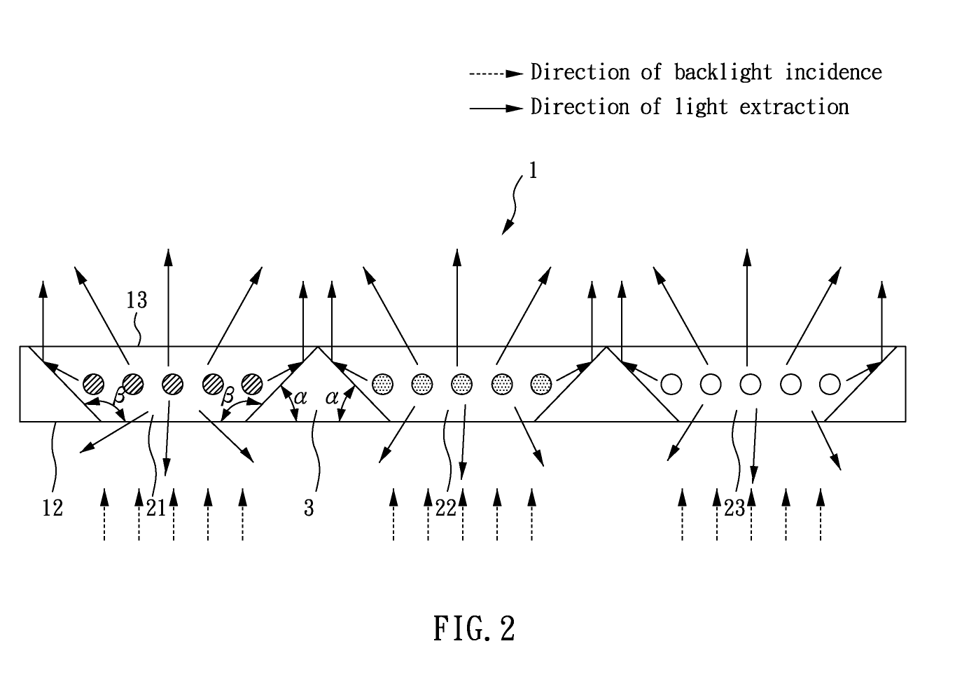

Referring now to the color conversion film 1 shown in FIG. 2, it comprises: a plurality of patterned pixels, which comprises a blue pixel 21, a red pixel 22, and a green pixel 23; and a plurality of white matrices 3, which is composed of barium sulfate. The color conversion film has a light-input surface 12 and a light-output surface 13, and the plurality of white matrices 3 are disposed between two adjacent pixels. In this illustration, the cross-sectional surface of the plurality of white matrices is triangular; the angle α between the inclined surface and the light-input surface of the white matrix is 50°; and the angle β between the inclined surface of the white matrix and the light-input surface of the adjacent pixel is 130°.

Accordingly, in Embodiments 1 and 2, after the color conversion film 1 is excited by backlight, a portion of the converted light beam is directly emitted, and a portion of the light arrives at the white matrix 3 and is reflected outward.

### EMBODIMENT 3

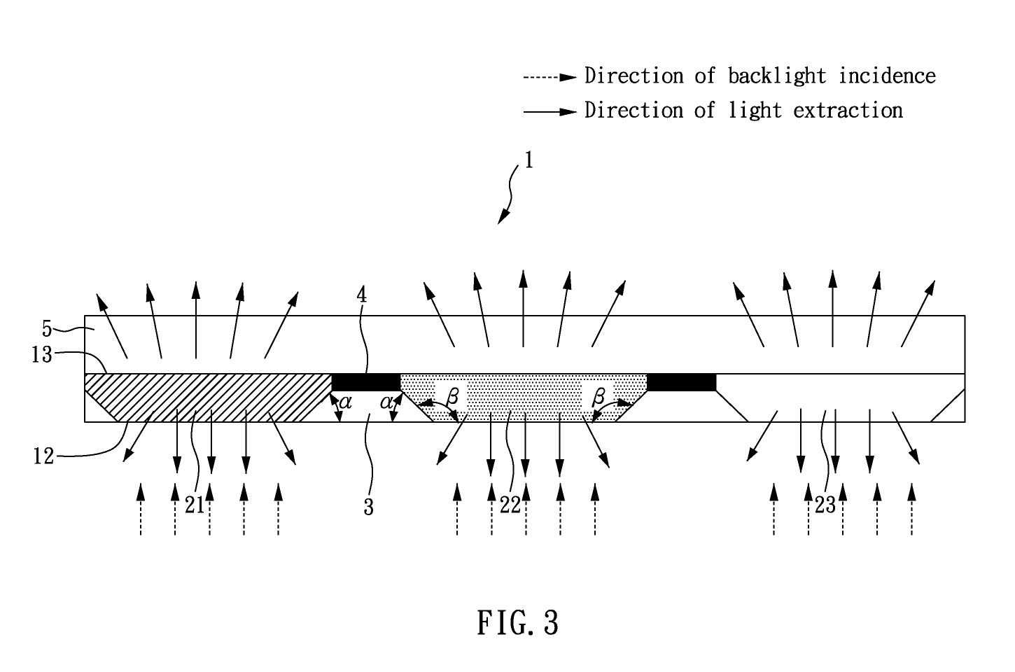

Referring now to the color conversion film 1 of FIG. 3, the color conversion film 1 has a light-input surface 12 and a light-output surface 13. The light conversion film 1 comprises: a plurality of pixels, which includes a blue pixel 21, a red pixel 22, and a green pixel 23; and a plurality of white matrices 3, which is composed of barium sulfate; a plurality of opaque regions 4, which is individually disposed on the light-output surface 13 of the plurality of white matrices 3; and a substrate 5, which is disposed on the light-output surface 13 of the color conversion film 1. The plurality of white matrices 3 are placed between two adjacent pixels, and the cross-sectional surface of the plurality of white matrices 3 is trapezoidal. In this illustration, the angle α between the inclined surface and the light-input surface of the white matrix is 50°; and the angle β between the inclined surface of the white matrix and the light-input surface of the adjacent pixel is 130°.

### EMBODIMENT 4

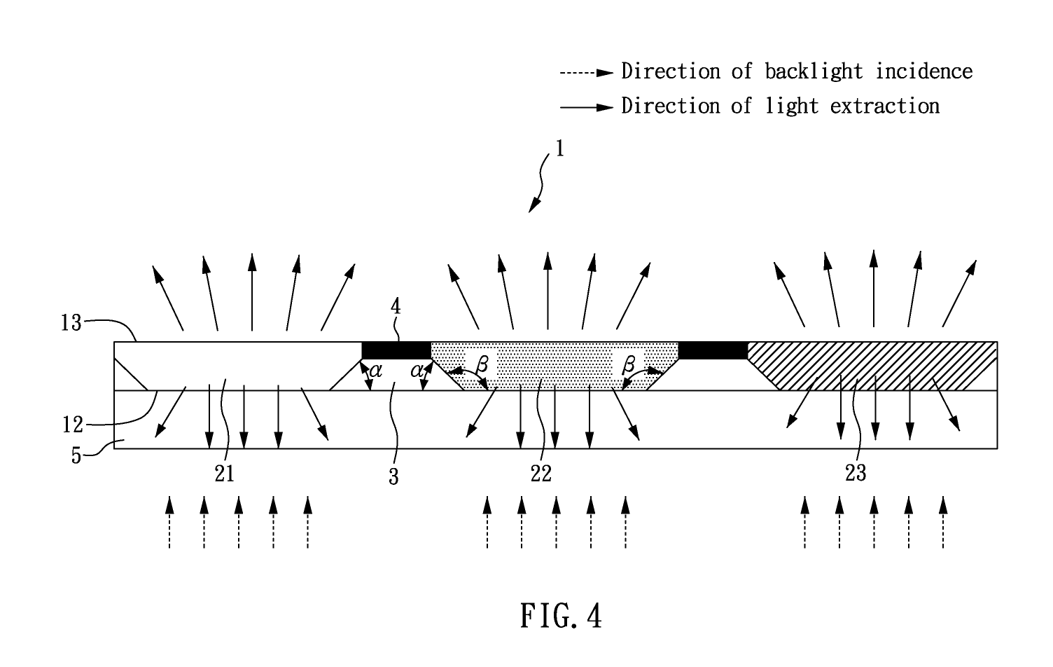

FIG. 4 shows a color conversion film 1 having a light-input surface 12 and a light-output surface 13. The color conversion film 1 comprises: a plurality of pixels, including a blue pixel 21, a red pixel 22, and a green pixel 23; and a plurality of white matrices 3, which is composed of barium sulfate; a plurality of opaque regions 4, which is individually disposed on the light-output surface 13 of the plurality of white matrices 3; and a substrate 5, which is disposed on the light-input surface 12 of the color conversion film 1. The plurality of white matrices 3 is respectively disposed between two adjacent pixels, and the cross-sectional surface of the plurality of white matrices is trapezoidal. In this illustration, the angle α between the inclined surface and the light-input surface of the white matrix is 50°; and the angle β between the inclined surface of the white matrix and the light-input surface of the adjacent pixel is 130°.

Accordingly, for the Embodiments 3 and 4, after the color conversion film 1 is excited by backlight, a portion of the converted light beam would be emitted outward directly, and a portion of the light will arrive at the white matrix 3 and be reflected outward.

The above embodiments are for the purpose of better description and are of exemplary nature only. The scope of right asserted by the present invention is based on the scope of claims in this application, and is not intended to be restricted by the above embodiments.

What is claimed is:

1. A color conversion film, comprising:
a plurality of pixels, which are composed of a fluorescent material; and
a plurality of white matrices, which are composed of a reflective material;
wherein, the color conversion film has a light-input surface and a light-output surface, and the plurality of white matrices is disposed between two adjacent ones of the plurality of pixels.

2. The color conversion film of claim 1, further comprising: a plurality of opaque regions, which are disposed on the light-output surface of the plurality of white matrices.

3. The color conversion film of claim 1, wherein the plurality of white matrices has an inclined surface.

4. The color conversion film of claim 3, wherein an angle between the inclined surface and the light-input surface of the plurality of white matrices is in a range of 40° to 50°.

5. The color conversion film of claim 3, wherein an angle between the inclined surface of the white matrix and the light-input surface of the adjacent pixel is greater than 90°.

6. The color conversion film of claim 1, wherein the reflective material is barium sulfate, strontium carbonate, zinc oxide, titanium oxide, magnesium oxide, zirconium dioxide, or silica.

7. The color conversion film of claim 1, wherein the plurality of pixels is independently selected from the group consisting of a red pixel, a green pixel, a blue pixel, a cyan pixel, a yellow pixel, and a colorless pixel.

8. The color conversion film of claim 1, further comprising: a substrate, which is disposed on the light-input surface or the light-output surface of the color conversion film.

9. A display device, comprising:
the color conversion film as claimed in claim 1.
